(19) United States
(12) Patent Application Publication
(10) Pub. No.: US 2013/0114022 A1
(43) Pub. Date: May 9, 2013

(54) LIGHT EMITTING DEVICE, SURFACE LIGHT SOURCE, LIQUID CRYSTAL DISPLAY DEVICE, AND LENS

(71) Applicant: Panasonic Corporation, Osaka (JP)

(72) Inventors: Tomoko IIYAMA, Osaka (JP); Daizaburo MATSUKI, Osaka (JP)

(73) Assignee: PANASONIC CORPORATION, Osaka (JP)

(21) Appl. No.: 13/728,585

(22) Filed: Dec. 27, 2012

Related U.S. Application Data
(63) Continuation of application No. PCT/JP2012/001369, filed on Feb. 29, 2012.

(30) Foreign Application Priority Data
May 31, 2011 (JP) 2011-121373

(51) Int. Cl. G02F 1/1335; F21V 13/04; F21V 5/04

(52) U.S. Cl. CPC G02F 1/133606; F21V 5/04; F21V 13/04
USPC 349/64; 362/311.09; 362/308; 362/237; 362/335; 362/328; 362/311.02

(57) ABSTRACT

A light emitting device includes plural light emitting diodes and plural lenses each of which expands the light from the light emitting diode. The lens includes an incident surface through which the light from the light emitting diode is entered at an optical axis and around the optical axis, and an output surface from which the incident light is output while radially expanded. The incident surface includes a continuous concave surface, the output surface includes a continuous convex surface, and the lens has different refractive powers in a first direction orthogonal to the optical axis and in a second direction orthogonal to the optical axis and the first direction.

### CROSS-REFERENCE TO RELATED APPLICATIONS

This is a continuation application of International Application No. PCT/JP2012/001369, with an international filing date of Feb. 29, 2012, which claims priority of Japanese Patent Application No.: 2011-121373 filed on May 31, 2011, the content of which is incorporated herein by reference.

### BACKGROUND OF THE INVENTION

1. Technical Field

The present disclosure relates to a light emitting device which expands directionality of light from a light source such as a light emitting diode (hereinafter simply referred to as an “LED”) by a lens. The disclosure also relates to a surface light source including a plurality of the light emitting devices, a liquid crystal display device in which the surface light source is disposed as a backlight at the back of a liquid crystal display panel, and a lens included in the light emitting device.

2. Description of the Related Art

In a backlight of a conventional large-size liquid crystal display device, many cold-cathode tubes are disposed iumediately below the liquid crystal panel, and the cold-cathode tubes are used together with a member(s) such as a diffuser plate and/or a reflector plate. Nowadays, the LED is used as the light source of the backlight. A luminous efficacy of the LED is improved, and expected as a low-power-consumption light source to replace a fluorescent lamp. In the light source for the liquid crystal display device, power consumption of the liquid crystal display device can be reduced by controlling lighting of the LED based on a video picture.

In the liquid crystal display device, many LEDs are disposed instead of the cold-cathode tube in the backlight in which the LED is used as the light source. Although the brightness can evenly be obtained on a surface of the backlight using the many LEDs, unfortunately cost increases because many LEDs are used. In order to solve the drawback, the approach that the number of LEDs is decreased by increasing an output per LED is promoted. For example, Japanese Patent Publication Laid-Open No. 2006-92983 proposes a light emitting device in which the surface light source having the even luminance is obtained by a small number of LEDs.

In order to obtain the surface light source in which the surface light source having the even luminance is obtained by a small number of LEDs, it is necessary to enlarge an illumination region that can be illuminated by one LED. In the light emitting device of Japanese Patent Publication Laid-Open No. 2006-92983, the light from the LED is radially expanded by the lens. Therefore, directionality of the light from the LED is expanded, and a wide range about an optical axis of the LED can be illuminated on the irradiated surface. Specifically, the lens used in the light emitting device of Japanese Patent Publication Laid-Open No. 2006-92983 is formed into a circular shape when viewed from above, and both a light incident surface and a light control output surface are rotationally symmetrical with respect to the optical axis. The light incident surface is formed into a concave surface. In the light control output surface, a portion near the optical axis is formed into a concave surface, and a portion outside the portion near the optical axis is formed into a convex surface.

On the other hand, Japanese Patent Publication Laid-Open No. 2008-10693 discloses a light emitting device in which a lens, in which a V-shape groove extending in a direction orthogonal to the optical axis is formed on the center of the light output surface, is used. According to the lens of the above light emitting device, the light from the LED is expanded while an angular distribution of a normal distribution is kept constant in the direction (a longitudinal direction) in which the V-shape groove extends. On the other hand, in a direction (a crosswise direction) orthogonal to the direction in which the V-shape groove extends, the light from the LED is expanded such that the angular distribution is largely recessed near the optical axis and such that the angular distribution is steeply raised on both sides of the optical axis.

### SUMMARY

In a current white LED, the white LED in which a YAG-based and/or TAG-based fluorescent material is provided in a blue LED element to generated pseudo-white light becomes a mainstream. The light source of the pseudo-white light is formed as follows. The blue LED element is bonded in a package, and a transparent resin with the fluorescent materials dispersed is filled so as to cover the blue LED element.

In the above light source, the pseudo-white light is obtained by blue light from the blue LED element and yellow light generated by the fluorescent material excited by the blue light. Thus a size of a blue light emission surface differs from a size of a yellow light emission surface. Therefore, in a case that such pseudo-white light is expanded using the lens of Japanese Patent Publication Laid-Open No. 2006-92983, the expansion of the light depends on the color, and color unevenness is generated on the irradiated surface in the surface light source, on which the light from the light source is irradiated. A tendency of the color unevenness becomes prominent when the lens with a stronger power expanding the light is used.

Since a luminous efficacy of the LED is being improved in recent years, there is a demand for a light emitting device in which an irradiation area per one light source on the irradiated surface is enlarged, the luminance and the color are equalized, and the low-cost and energy-saving can be achieved.

The light emitting device of Japanese Patent Publication Laid-Open No. 2008-10693 does not satisfy the demand because anisotropy is intentionally generated in the radiated light.

In view of the above demand, the disclosure provides a light emitting device, in which the color unevenness generated on the irradiated surface due to the different colors included in the light source can be reduced to equalize the luminance and the color in a state that a light distribution lens having the power to widely expand the light is used, a surface light source including the light emitting device, a liquid crystal display device, and a lens included in the light emitting device.

In order to solve the problem, the disclosure has the following configuration.

In accordance with a first aspect of the disclosure, a light emitting device that radiates light at an optical axis and around the optical axis includes a light emitting element, a light source, and a lens. The light source has a resin which covers the light emitting element and in which a fluorescent material is dispersed. The lens radially expands light from the light source, and has different refractive powers in a first direction orthogonal to the optical axis and in a second direction orthogonal to the optical axis and the first direction.

According to the light emitting device of the first aspect, the refractive power in the first direction orthogonal to the optical axis differs from the refractive power in the second direction orthogonal to the optical axis and the first direction, thereby reducing a total reflection component of the light generated on the output surface side of the lens. Accordingly, based on the light emitting device of the first aspect of the disclosure, the light emitting device, in which the color unevenness generated on the irradiated surface due to the different colors included in the light source is reduced to equalize the luminance and the color even in a state that the lens having the power widely expanding the light is used, can be provided.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 is a configuration diagram of a liquid crystal display device according to a first embodiment of the disclosure;

FIG. 2 is a configuration diagram of a surface light source according to a second embodiment of the disclosure;

FIG. 3 is a partial cross-sectional view of the surface light source in FIG. 2;

FIG. 4 is a plan view of a light emitting device according to a third embodiment of the disclosure;

FIG. 5A is a cross-sectional view taken on a line IIA-IIA in FIG. 4;

FIG. 5B is a cross-sectional view taken on a line IIB-IIB of FIG. 4;

FIG. 6A is a perspective view illustrating a specific example of a light source;

FIG. 6B is a perspective view illustrating a specific example of the light source;

FIG. 6C is a perspective view illustrating a specific example of the light source;

FIG. 7 is a graph illustrating a luminance distribution on an emission surface of the light source used in the light emitting device;

FIG. 8 is an explanatory view of a light emitting device of Example 1;

FIG. 9A is a graph (of Table 1) illustrating a relationship between R and, sagAX and sagAY, which indicates an incident surface shape of a lens used in the light emitting device of Example 1;

FIG. 9B is a graph (of Table 1) illustrating a relationship between R and sagB, which indicate the incidents surface shape of the lens used in the light emitting device of Example 1;

FIG. 10 is a graph illustrating an illuminance distribution of the light emitting device of Example 1;

FIG. 11 is a graph illustrating an illuminance distribution when the surface light source is constructed only by the light source in order to check an effect of the light emitting device of Example 1;

FIG. 12 is a graph illustrating an illuminance distribution of the light emitting device having a similar configuration to Example 1 except that an incident surface of a lens is rotationally symmetrical;

FIG. 13 is a graph illustrating a distribution of a Y value of the chromaticity of Example 1;

FIG. 14 is a graph illustrating a distribution of a Y value of the chromaticity of the light emitting device having a similar configuration to Example 1 except that the incident surface of the lens is rotationally symmetrical;

FIG. 15 is a graph illustrating a illuminance distribution when a reflection unit of the light emitting device of Example 1 is eliminated;

FIG. 16 is a graph illustrating an illuminance distribution of a surface light source of Example 1; and

FIG. 17 is a graph illustrating an illuminance distribution of a surface light source in which only the light source is used.

### DETAILED DESCRIPTION

Hereinafter, embodiments of the disclosure will be described in detail with reference to the drawings. However, the detailed description beyond necessity is occasionally omitted. For example, the detailed description of a well-known item and the detailed description of a substantially identical configuration are occasionally omitted. Therefore, the unnecessarily redundant description is avoided for the purpose of easy understanding of those skilled in the art.

The inventors provide the accompanying drawings and the following description in order that those skilled in the art sufficiently understand the disclosure, however, the scope defined by the appended claims is not limited by the accompanying drawings and the following description.

### First Embodiment

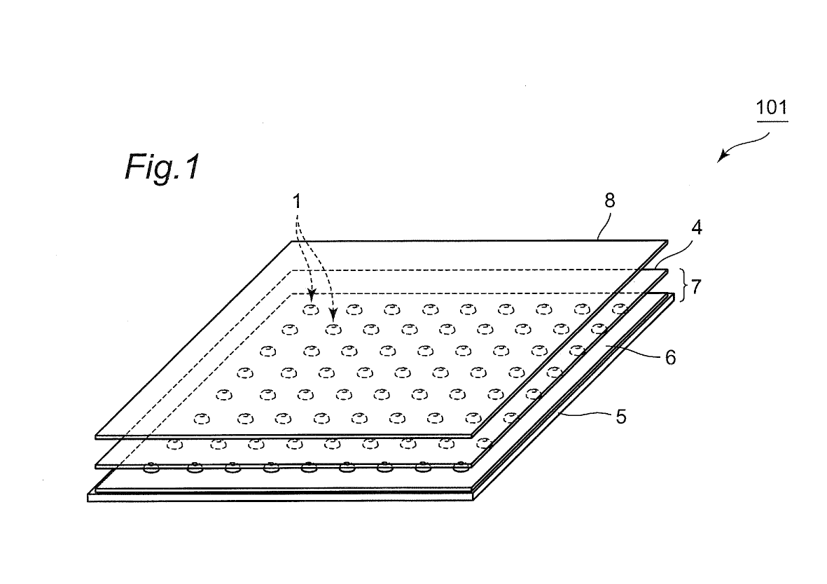

FIG. 1 is a view illustrating a whole schematic configuration of a liquid crystal display device 101 according to a first embodiment of the disclosure. The liquid crystal display device 101 includes a liquid crystal display panel 8 and a surface light source 7 that is disposed on the back side (an opposite side to a display surface) of the liquid crystal display panel 8. The surface light source 7 includes a light emitting device 1 and a diffuser plate 4 that is disposed opposite to the light emitting device 1. The surface light source 7 is described in detail later in a second embodiment.

A plurality of the light emitting devices 1 are disposed opposite to the diffuser plate 4 while dispersed in a planar manner, and the light emitting devices 1 irradiate a rear surface (irradiated surface) of the diffuser plate 4 opposite to the light emitting device 1 with the light having the equalized illuminance. The light is diffused by the diffuser plate 4 to output from a surface (an irradiation surface) of the diffuser plate 4, thereby illuminating the liquid crystal display panel 8.

Optical sheets, such as a diffusion sheet and a prism sheet, may be disposed between the liquid crystal display panel 8 and the surface light source 7. In this case, the light transmitted through the diffuser plate 4 is further diffused by the optical sheet to illuminate the liquid crystal display panel 8.

### Second Embodiment

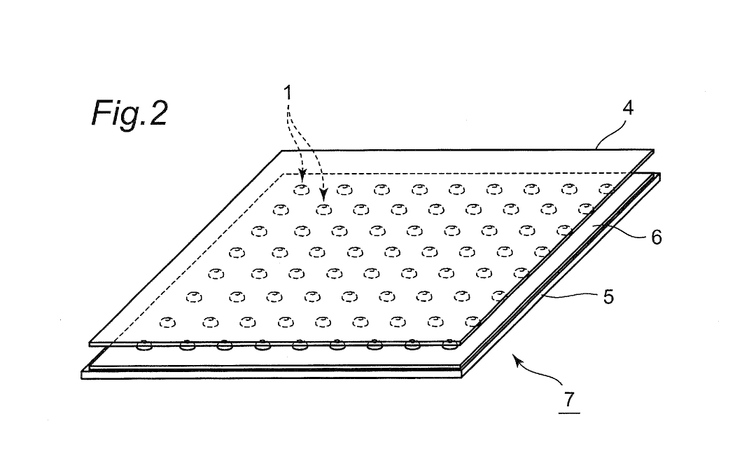

The surface light source 7 according to a second embodiment of the disclosure will be described in detail. FIG. 2 is a configuration diagram of the surface light source 7. As described above, the surface light source 7 includes the plurality of light emitting devices 1 and the diffuser plate 4 that is disposed so as to cover the light emitting devices 1. Each of the light emitting devices 1 includes a light source 2 and a lens 3 that is disposed while covering the light source 2. The diffuser plate 4 extends in a direction orthogonal to the optical axis of the light source 2. The light emitting devices 1 are disposed in a bottom portion in a chassis, and an opening of the chassis that is provided opposite to the bottom portion is closed by the diffuser plate 4 to form the surface light source 7. The light emitting devices 1 may be disposed in any manner as long as they are disposed opposite to the whole surface or the substantially whole surface of the diffuser plate 4 while dispersed in the planar manner. As illustrated in FIG. 2, for example, the light emitting devices 1 may two-dimensionally be arrayed, or the light emitting devices 1 may be disposed in a zigzag manner.

The light source 2 and the lens 3, which constitute the light emitting device 1, are described in detail later in a third embodiment.

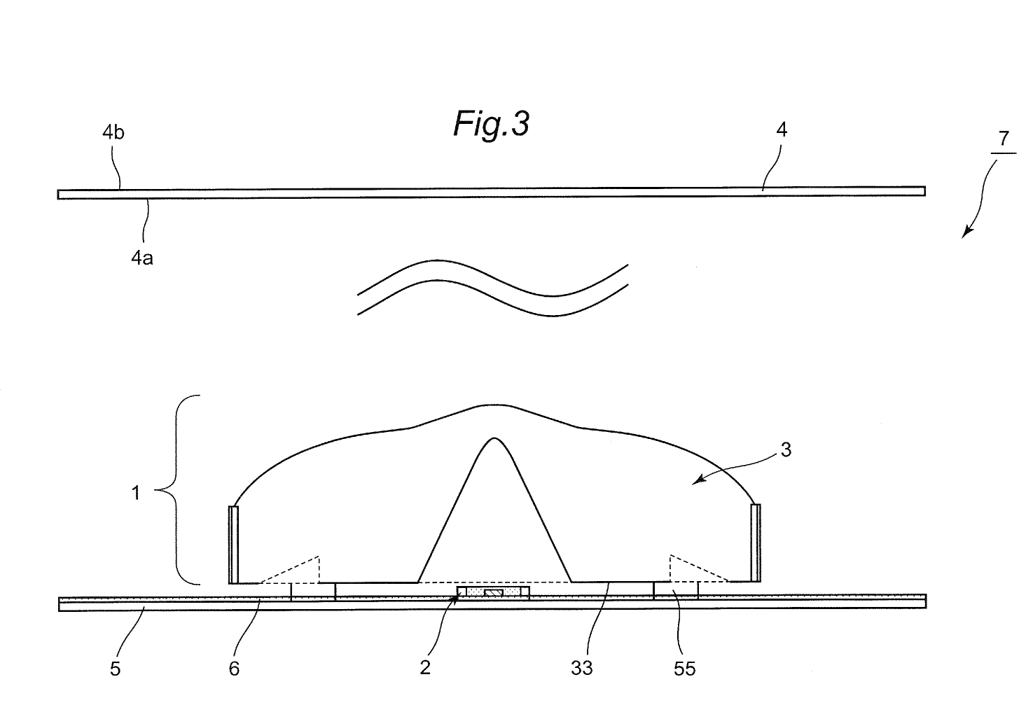

As illustrated in FIG. 3, the surface light source 7 includes a board 5 that is disposed opposite to the diffuser plate 4 with the light emitting device 1 interposed therebetween. The light sources 2 of the light emitting devices 1 are mounted on the board 5. In the second embodiment, a bottom surface 33 of the lens 3 is bonded on the board 5 with support posts 55 interposed therebetween. A reflecting sheet 6 is disposed on the board 5 such that the reflecting sheet 6 covers the board 5 while avoiding the light source 2, namely, such that the reflecting sheet 6 covers the board 5 while exposing the light source 2. Alternatively, a reflecting coating may be provided on the board 5 instead of the reflecting sheet 6. The reflecting sheet 6 and the reflecting coating correspond to an example of a reflecting member. It is not always necessary that the bottom surface 33 of the lens 3 be bonded to the board 5 with the support posts 55 interposed therebetween, but the bottom surface 33 may directly be bonded to the board 5. The support post 55 may be formed while being integral with the lens 3.

The light emitting devices 1 irradiate an irradiated surface 4a of the diffuser plate 4 with the light. The diffuser plate 4 radiates the light, with which the irradiated surface 4a is irradiated, while the light is diffused from a radiation surface 4b. Each light emitting device 1 irradiates a wide range of the irradiated surface 4a of the diffuser plate 4 with the light having the equalized illuminance, and the light is diffused by the diffuser plate 4, allowing the construction of the surface light source 7 in which a small amount of luminance unevenness is generated. A mechanism in which the color unevenness is reduced in the light emitting device 1 to be able to irradiate the diffuser plate 4 with the light having the equalized luminance and color is described later in the third embodiment.

The light from the light emitting devices 1 is diffused by the diffuser plate 4 to return to the side of the light emitting devices 1 or to be transmitted through the diffuser plate 4. The light, which returns to the side of the light emitting devices 1 to impinge on the reflecting sheet 6, is reflected by the reflecting sheet 6 and enters into the diffuser plate 4 again.

### Third Embodiment

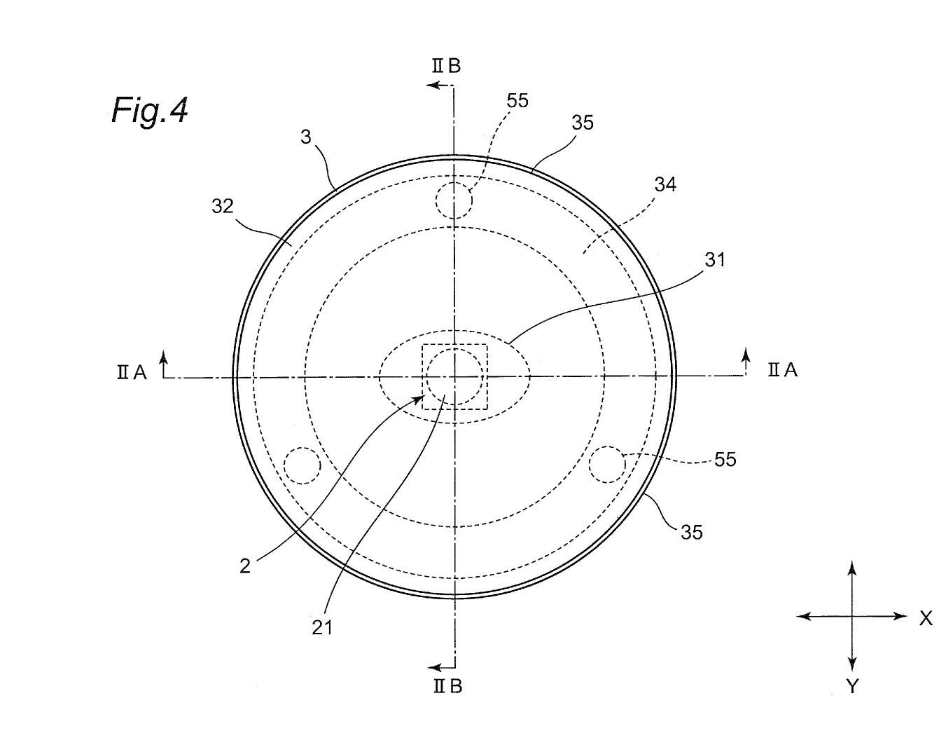

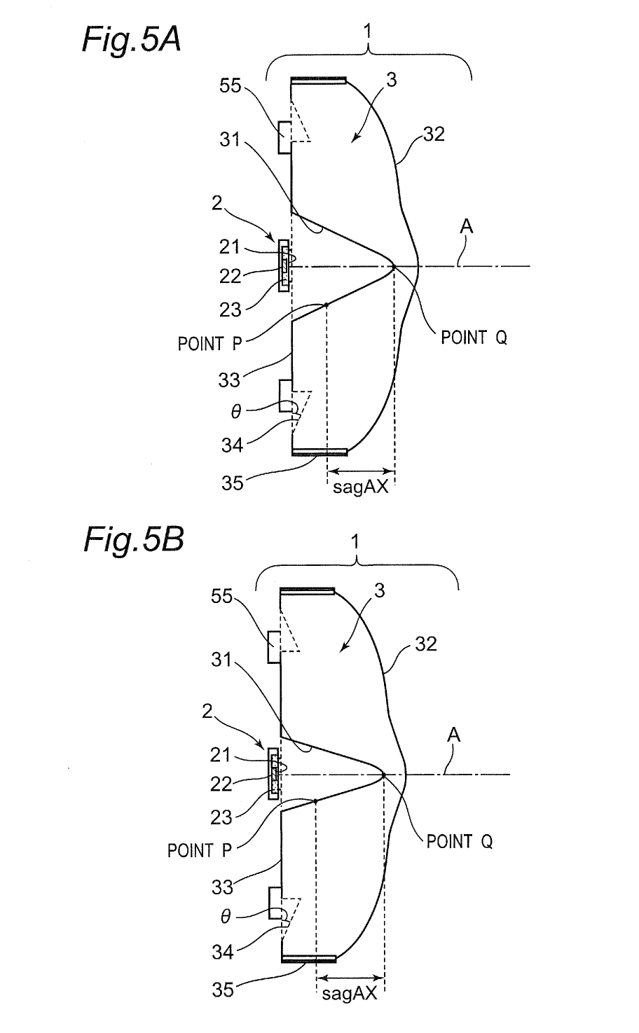

The light emitting device 1 according to a third embodiment of the disclosure will be described in detail. FIGS. 4, 5A, and 5B are views illustrating a configuration of the light emitting device 1. As described above, the light emitting device 1 includes the light source 2 and the lens 3 that radially expands the light emitted from the light source 2. For example, the light emitting device 1 radiates light onto the irradiated surface 4a of the diffuser plate 4 at an optical axis A and at the substantially circular shape around the optical axis A. That is, directionality of the light emitted from the light source 2 is expanded by the lens 3, whereby the wide range of the irradiated surface 4a of the diffuser plate 4 is illuminated at the optical axis A and about the optical axis A. The illuminance distribution of the irradiated surface 4a becomes the maximum at the optical axis A, and monotonously decreased toward a surrounding region from the optical axis A.

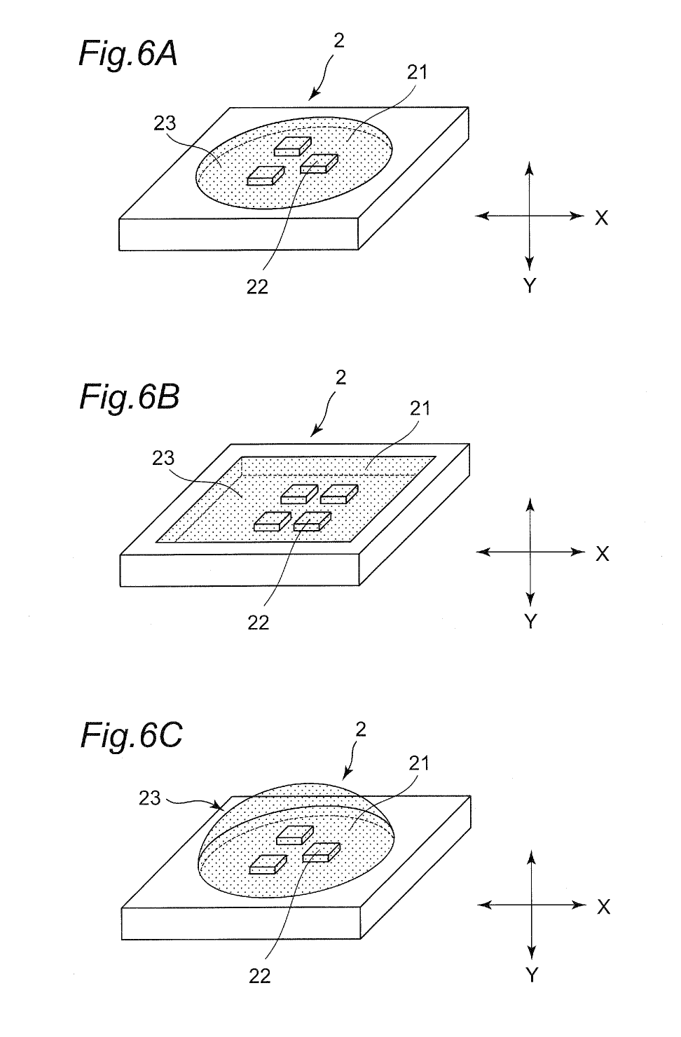

An LED is used as the light source 2 in the third embodiment. Namely, a light emitting element 22 is bonded onto a board and is sealed by a transparent resin 23 into which the fluorescent materials dispersed. The transparent resin 23 corresponds to the fluorescent layer. A flat surface of the LED becomes an emission surface 21. For example, the emission surface 21 may be formed into a circular shape as illustrated in FIG. 6A, or formed into a rectangular shape as illustrated in FIG. 6B. As illustrated in FIG. 6C, the light source 2 may be constructed by the light emitting element 22 and the dome-shaped transparent resin 23, which is formed on the light emitting element 22 and in which the fluorescent materials are dispersed, and the emission surface 21 may be constructed by a three-dimensional surface of the transparent resin 23.

The number of light emitting elements 22 used as the light source 2 may vary depending on a kind of the light source. At this point, the light emitting elements 22 may not be disposed in the rotationally symmetrical manner. For the sake of convenience, the emission surface 21 includes a first direction orthogonal to the optical axis and a second direction orthogonal to the optical axis and the first direction, and the first direction is set to the X-direction while the second direction is set to the Y-direction.

The light radiated from the emission surface 21 of the light source 2 is pseudo-white light made by blue light emitted by the light emitting element 22 and yellow light from the fluorescent material excited by the blue light. Therefore, there is generated a difference in emission areas between the blue light and the yellow light in a near field. Additionally, a light distribution changes based on the disposition of the light emitting element 22. Therefore, in the case that the light distribution has anisotropy according to the disposition of the light emitting element, the light distribution having the larger difference in emission areas between the blue light and the yellow light is defined as the X-direction, and the light distribution having the smaller difference is defined as the Y-direction, for the sake of convenience.

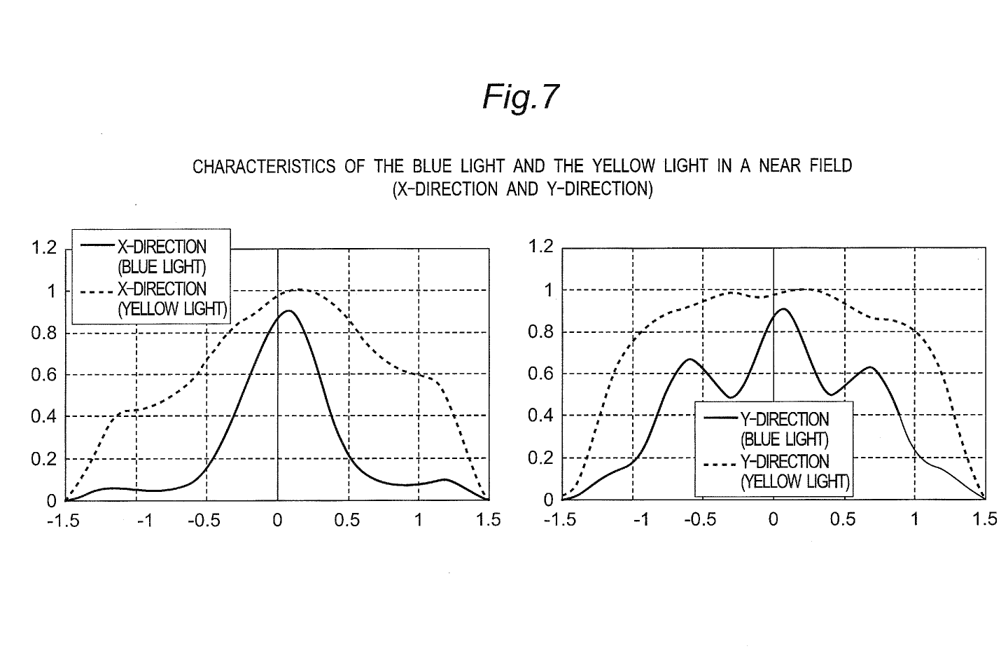

FIG. 7 illustrates a luminance distribution on a line extends in the X-direction through the optical axis A in the emission surface 21 of the light source 2 and a luminance distribution on a line extends in the Y-direction through the optical axis A in each color of the lights. In FIG. 7, a vertical axis indicates the illuminance normalized by the maximum value, and a horizontal axis indicates the distance (mm) from the optical axis. As illustrated in FIG. 7, the yellow light differs from the blue light in a range of the luminance distribution on the emission surface 21. Specifically, the luminance distribution of the yellow light is wider than that of the blue light. Thus, the luminance distribution of the light radiated from the light source 2 varies according to the color of the light. Therefore, in the case that the light emitting device 1 that generates the pseudo-white light is used like the third embodiment, it is necessary to reduce the color unevenness.

The lens 3 is made of a transparent material having a predetermined refractive index. For example, the refractive index of the transparent material ranges from about 1.4 to about 2.0. Examples of the transparent material include resins, such as an epoxy resin, a silicone resin, an acrylic resin, and polycarbonate, glass, and rubbers, such as a silicone rubber. Among others, the epoxy resin or the silicone rubber, which are conventionally used as an LED sealing resin, can be used for the lens 3.

Specifically, as illustrated in FIG. 5A, the lens 3 includes an incident surface 31 through which the light from the light source 2 is entered into the lens 3 and an output surface 32 from which the light incident to the lens 3 is output. A maximum outer diameter of the output surface 32 defines an effective diameter of the lens 3. The lens 3 also has the bottom surface 33. The bottom surface 33 is located around the incident surface 31, and located on the opposite side to the output surface 32 in the optical axis direction. A reflection unit 34, which is formed into a circular or elliptical shape around the optical axis A as a center position, is provided in the bottom surface 33. In the third embodiment, a ring 35 is provided between the output surface 32 and the bottom surface 33 so as to overhang the outside in the diametrical direction. The ring 35 has a substantial U-shape in section, and an outer circumferential edge of the output surface 32 and an outer circumferential edge of the bottom surface 33 are coupled by the ring 35. However, the ring 35 may be eliminated, and the outer circumferential edge of the output surface 32 and the outer circumferential edge of the bottom surface 33 may be coupled by an end surface having a linear shape or a circular arc shape in section. The components of the lens 3 will further be described in detail below.

In the third embodiment, the incident surface 31 is a continuously concave surface. The light source 2 is disposed away from the incident surface 31 of the lens 3. In the third embodiment, the output surface 32 is a continuously convex surface that is rotationally symmetrical with respect to the optical axis A. For example, the ring-like bottom surface 33 surrounding the incident surface 31 is flat. In the third embodiment, the emission surface 21 of the light source 2 is substantially in the same level as the flat bottom surface 33 in the optical axis direction in which the optical axis A extends.

After the light from the light source 2 is entered into the lens 3 through the incident surface 31, the light is output from the output surface 32, and reaches, for example, the irradiated surface 4a of the diffuser plate 4 as described above. The light emitted from the light source 2 is extended by refraction actions of the incident surface 31 and the output surface 32, and reaches the wide range of the irradiated surface 4a.

The lens 3 plays a role in reducing the color unevenness on the irradiated surface 4a, which is generated by the blue light and the yellow light radiated from light source 2 with the different emission areas. In order to implement the role, the lens 3 is configured such that the refractive power in the X-direction differs from the refractive power in the Y-direction. In the third embodiment, the incident surface 31 includes an anamorphic curved surface in which the X-direction differs from the Y-direction in a configuration of curvature, whereby the refractive power in the X-direction differs from the refractive power in the Y-direction.

As described above, in the third embodiment, the incident surface 31 is configured to include the anamorphic curved surface. Alternatively, the output surface 32 may be configured to include the anamorphic curved surface. That is, at least one of the incident surface 31 and the output surface 32 may be configured to include the anamorphic curved surface.

At this point, it is noted that the refractive power does not mean a concept of a lens “power” that is generally used in design of an optical system and/or design of an imaging system, namely, does not mean that a curvature of the lens varies near the optical axis in the case of an aspherical lens. As used in the present specification and claims the “refractive power” means a concept in which, at least one of the incident surface 31 and the output surface 32 has a shape equivalent to a surface of a spheroid, and the cross-sectional shape orthogonal to the optical axis A has the elliptical shape at any position in the optical axis direction. In other words, the X-direction differs from the Y-direction in a distance from the optical axis A of the cross-sectional shape orthogonal to the optical axis A, or the X-direction differs from the Y-direction in the direction in which the light is emitted from the incident surface 31 and the output surface 32 even when the light from the light source 2 has the same angle of incident at the incident surface 31 and the output surface 32, namely, a light distribution direction is different in the X-direction and the Y-direction. Hereinafter the curved surface having the above configuration is referred to as “anamorphic”.

Particularly, as illustrated in FIGS. 5A and 5B, the incident surface 31 has a vertex Q on the optical axis A. Assuming that a sag amount (as to a sign, from a vertex Q toward the side of the light source 2 is negative, and the opposite side to the light source 2 from the vertex Q is positive) is a distance along the optical axis A (that is, a distance in the optical axis direction) from the vertex Q to a point P on the incident surface 31, the incident surface 31 has a shape in which a sag amount sagAX in the X-direction differs from a sag amount sagAY in the Y-direction at the same position located the distance R radially away from the optical axis A (that is, on a concyclic point about the optical axis A). The incident surface 31 may extend toward the side of the light source 2, after the incident surface 31 retreats from the vertex Q toward the opposite side to the light source 2 such that the sag amount becomes positive near the optical axis A.

According to the light emitting device 1 having the above configuration, the color unevenness generated by the light source 2 is reduced by the lens 3. Accordingly, although the relatively small lens 3 is used, the light can be radiated while the color unevenness that is a characteristic of the light source 2 is reduced.

### Example 1

The light emitting device 1 of Example 1 will be described below as a specific numerical example of the disclosure.

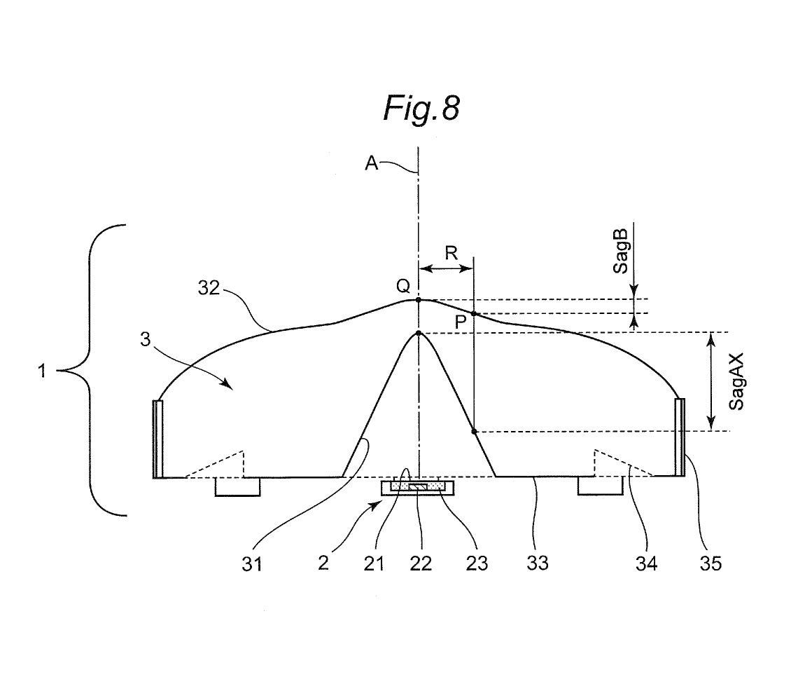

FIG. 8 is a cross-sectional view of the light emitting device 1 of Example 1. The lens 3, in which the whole surface of the incident surface 31 is the anamorphic curved surface while the output surface 32 is rotationally symmetrical, is used in Example 1.

In FIG. 8, the numerals Q, P, and sagAX (sagAY) are identical to those in FIGS. 5A and 5B. In FIG. 8, the numeral sagB designates a sag amount of the output surface 32 at the position located the distance R away from the optical axis A.

### Example 1

In Example 1, the general-purpose LED in which the emission surface 21 has a size of about φ 3.0 mm is used as the light source 2 in order that the directionality of the light from the light source 2 is expanded to suppress the color unevenness. In Example 1, the lens 3 has an effective diameter of 20.7 mm. The lens 3 has a thickness of 1.2 mm in the center of the optical axis. Table 1 illustrates specific numerical values of Example 1.

TABLE 1

| X-axis | SagAX | Y-axis | SagAY | X- or Y-axis | SagB | X- or Y-axis | SagB |
|---|---|---|---|---|---|---|---|
| 0.00 | 0.000 | 0.00 | 0.000 | 0.00 | 0.000 | 5.30 | −0.709 |
| 0.05 | −0.004 | 0.05 | −0.005 | 0.10 | 0.000 | 5.40 | −0.724 |
| 0.10 | −0.016 | 0.10 | −0.018 | 0.20 | −0.001 | 5.50 | −0.741 |
| 0.15 | −0.035 | 0.15 | −0.042 | 0.30 | −0.002 | 5.60 | −0.759 |
| 0.20 | −0.062 | 0.20 | −0.074 | 0.40 | −0.004 | 5.70 | −0.777 |
| 0.25 | −0.096 | 0.25 | −0.115 | 0.50 | −0.007 | 5.80 | −0.797 |
| 0.30 | −0.138 | 0.30 | −0.165 | 0.60 | −0.013 | 5.90 | −0.818 |
| 0.35 | −0.187 | 0.35 | −0.224 | 0.70 | −0.019 | 6.00 | −0.840 |
| 0.40 | −0.242 | 0.40 | −0.292 | 0.80 | −0.028 | 6.10 | −0.863 |
| 0.45 | −0.303 | 0.45 | −0.367 | 0.90 | −0.038 | 6.20 | −0.888 |
| 0.50 | −0.371 | 0.50 | −0.452 | 1.00 | −0.050 | 6.30 | −0.914 |
| 0.55 | −0.445 | 0.55 | −0.544 | 1.10 | −0.064 | 6.40 | −0.941 |
| 0.60 | −0.524 | 0.60 | −0.644 | 1.20 | −0.079 | 6.50 | −0.970 |
| 0.65 | −0.608 | 0.65 | −0.751 | 1.30 | −0.096 | 6.60 | −0.999 |
| 0.70 | −0.697 | 0.70 | −0.866 | 1.40 | −0.114 | 6.70 | −1.030 |
| 0.75 | −0.791 | 0.75 | −0.987 | 1.50 | −0.132 | 6.80 | −1.062 |
| 0.80 | −0.889 | 0.80 | −1.116 | 1.60 | −0.152 | 6.90 | −1.095 |
| 0.85 | −0.991 | 0.85 | −1.251 | 1.70 | −0.173 | 7.00 | −1.129 |
| 0.90 | −1.097 | 0.90 | −1.392 | 1.80 | −0.193 | 7.10 | −1.164 |
| 0.95 | −1.206 | 0.95 | −1.540 | 1.90 | −0.214 | 7.20 | −1.200 |
| 1.00 | −1.318 | 1.00 | −1.693 | 2.00 | −0.235 | 7.30 | −1.237 |
| 1.05 | −1.434 | 1.05 | −1.851 | 2.10 | −0.256 | 7.40 | −1.275 |
| 1.10 | −1.552 | 1.10 | −2.015 | 2.20 | −0.277 | 7.50 | −1.313 |
| 1.15 | −1.673 | 1.15 | −2.184 | 2.30 | −0.297 | 7.60 | −1.353 |
| 1.20 | −1.796 | 1.20 | −2.358 | 2.40 | −0.317 | 7.70 | −1.394 |
| 1.25 | −1.922 | 1.25 | −2.536 | 2.50 | −0.336 | 7.80 | −1.437 |
| 1.30 | −2.050 | 1.30 | −2.719 | 2.60 | −0.354 | 7.90 | −1.481 |
| 1.35 | −2.180 | 1.35 | −2.906 | 2.70 | −0.371 | 8.00 | −1.526 |
| 1.40 | −2.311 | 1.40 | −3.097 | 2.80 | −0.388 | 8.10 | −1.574 |
| 1.45 | −2.445 | 1.45 | −3.292 | 2.90 | −0.405 | 8.20 | −1.624 |
| 1.50 | −2.580 | 1.50 | −3.490 | 3.00 | −0.420 | 8.30 | −1.676 |
| 1.55 | −2.716 | 1.55 | −3.692 | 3.10 | −0.435 | 8.40 | −1.731 |
| 1.60 | −2.854 | 1.60 | −3.897 | 3.20 | −0.449 | 8.50 | −1.788 |
| 1.65 | −2.994 | 1.65 | −4.105 | 3.30 | −0.463 | 8.60 | −1.848 |
| 1.70 | −3.134 | 1.70 | −4.317 | 3.40 | −0.476 | 8.70 | −1.911 |
| 1.75 | −3.276 | 1.75 | −4.531 | 3.50 | −0.488 | 8.80 | −1.977 |
| 1.80 | −3.419 | 1.80 | −4.748 | 3.60 | −0.501 | 8.90 | −2.045 |
| 1.85 | −3.563 | 1.85 | −4.967 | 3.70 | −0.513 | 9.00 | −2.116 |
| 1.90 | −3.708 | 1.90 | −5.189 | 3.80 | −0.525 | 9.10 | −2.190 |
| 1.95 | −3.853 | 1.95 | −5.414 | 3.90 | −0.536 | 9.20 | −2.268 |
| 2.00 | −4.000 | 1.97 | −5.500 | 4.00 | −0.547 | 9.30 | −2.349 |
| 2.05 | −4.147 | | | 4.10 | −0.559 | 9.40 | −2.435 |
| 2.10 | −4.296 | | | 4.20 | −0.570 | 9.50 | −2.528 |
| 2.15 | −4.445 | | | 4.30 | −0.581 | 9.60 | −2.629 |
| 2.20 | −4.594 | | | 4.40 | −0.593 | 9.70 | −2.741 |
| 2.25 | −4.745 | | | 4.50 | −0.604 | 9.80 | −2.866 |
| 2.30 | −4.895 | | | 4.60 | −0.616 | 9.90 | −3.006 |
| 2.35 | −5.047 | | | 4.70 | −0.628 | 10.00 | −3.165 |
| 2.40 | −5.199 | | | 4.80 | −0.640 | 10.10 | −3.340 |
| 2.50 | −5.500 | | | 4.90 | −0.653 | 10.20 | −3.530 |
| | | | | 5.00 | −0.666 | 10.30 | −3.725 |
| | | | | 5.10 | −0.680 | 10.35 | −3.819 |
| | | | | 5.20 | −0.694 | | |

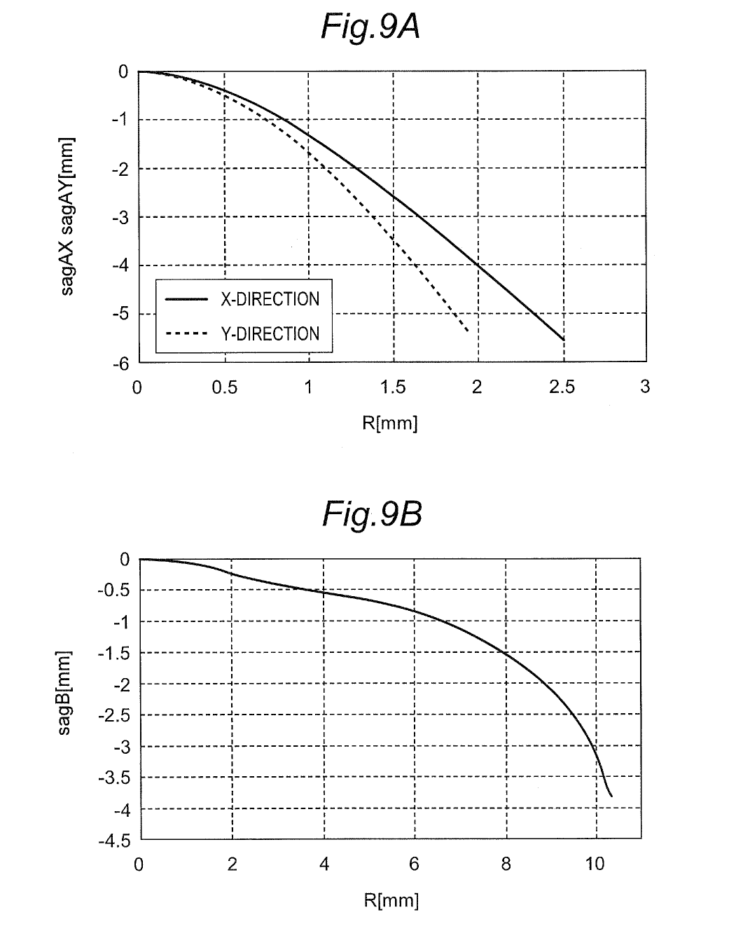

FIG. 9A is a graph illustrating between values (R) of an X-axis and a Y-axis, and sagAX and sagAY in Table 1, and FIG. 9B is a graph illustrating between values (R) of the X-axis and the Y-axis, and sagB.

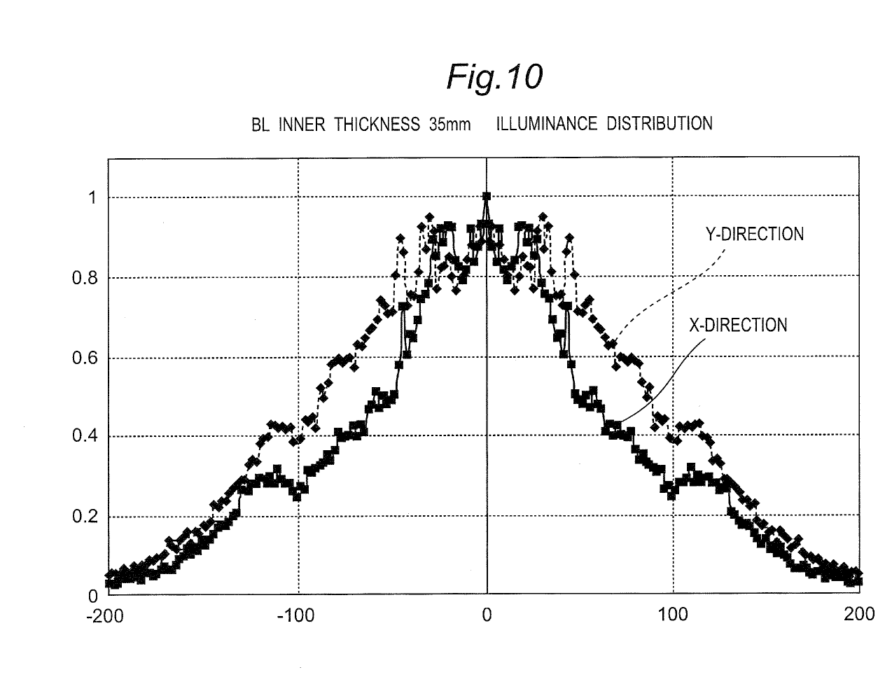

FIG. 10 illustrates an illuminance distribution on the irradiated surface 4a of the diffuser plate 4 when the irradiated surface 4a is disposed at the position 35 mm away from the emission surface 21 of the light source 2 in the optical axis direction using the light emitting device 1 of Example 1. In FIG. 10, a vertical axis indicates the illuminance normalized by the maximum value, and a horizontal axis indicates the distance (mm) from the optical axis.

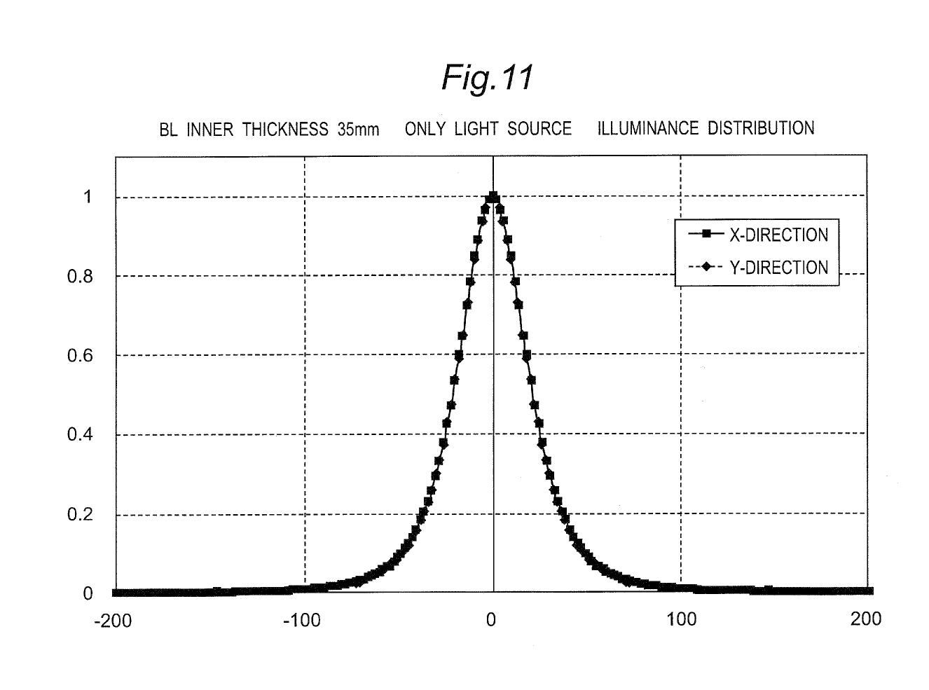

FIG. 11 illustrates an illuminance distribution when a surface light source is constructed only by the light source 2 with no use of the lens 3 in order to check the effect of the light emitting device 1 of Example 1.

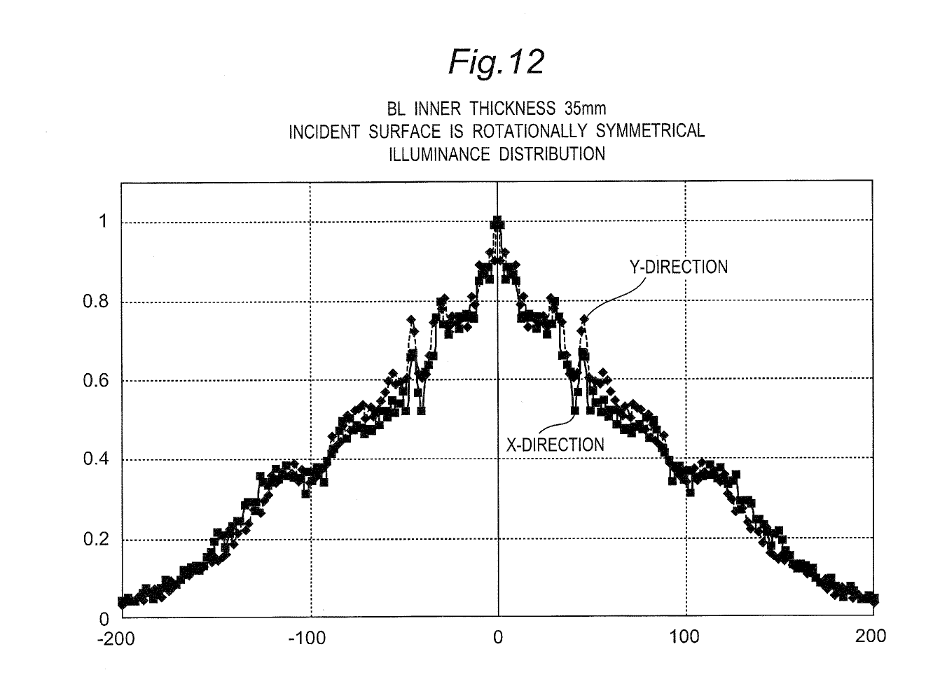

FIG. 12 illustrates an illuminance distribution on the irradiated surface 4a (not illustrated) of the diffuser plate 4 in a case that an incident surface 31 of the lens 3 is constructed by a curved surface that is rotationally symmetrical with respect to the optical axis when the irradiated surface 4a is disposed at the position 35 mm away from the emission surface 21 of the light source 2 in the optical axis direction using a light emitting device having a configuration corresponding to that of Example 1.

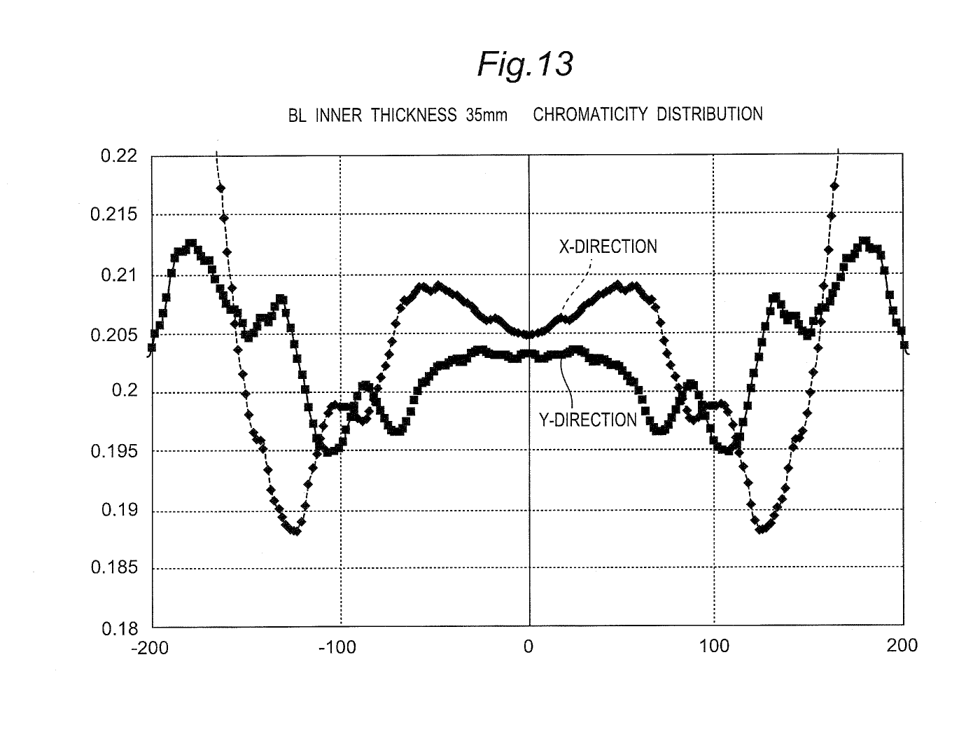

FIG. 13 illustrates a distribution of a Y value of the chromaticity on the irradiated surface 4a when the irradiated surface 4a is disposed at the position 35 mm away from the emission surface 21 of the light source 2 in the optical axis direction using the light emitting device 1 of Example 1. In FIG. 13, a vertical axis indicates the illuminance normalized by the maximum value, and a horizontal axis indicates the distance (mm) from the optical axis.

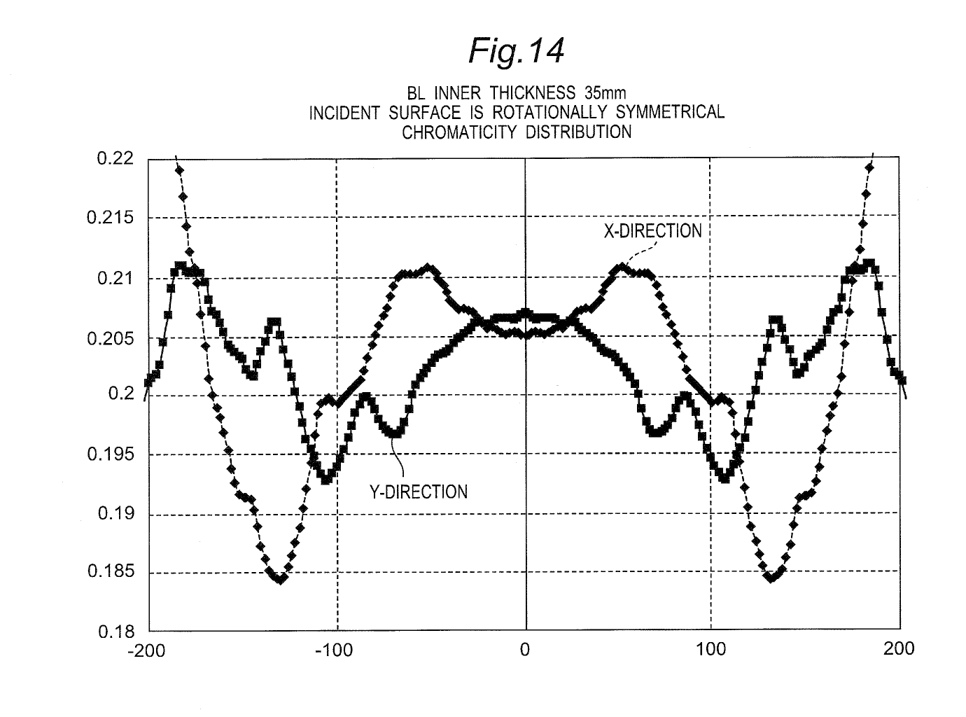

FIG. 14 illustrates a distribution of a Y value of the chromaticity on the irradiated surface 4a in a case that an incident surface 31 of the lens 3 is constructed by a curved surface that is rotationally symmetrical with respect to the optical axis when the irradiated surface 4a is disposed at the position 35 mm away from the emission surface 21 of the light source 2 in the optical axis direction using a light emitting device having a configuration corresponding to that of Example 1.

As can be seen from FIGS. 13 and 14, the incident surface 31 of the lens 3 is formed into the anamorphic aspheric surface, which allows the color unevenness to be reduced on the irradiated surface 4a.

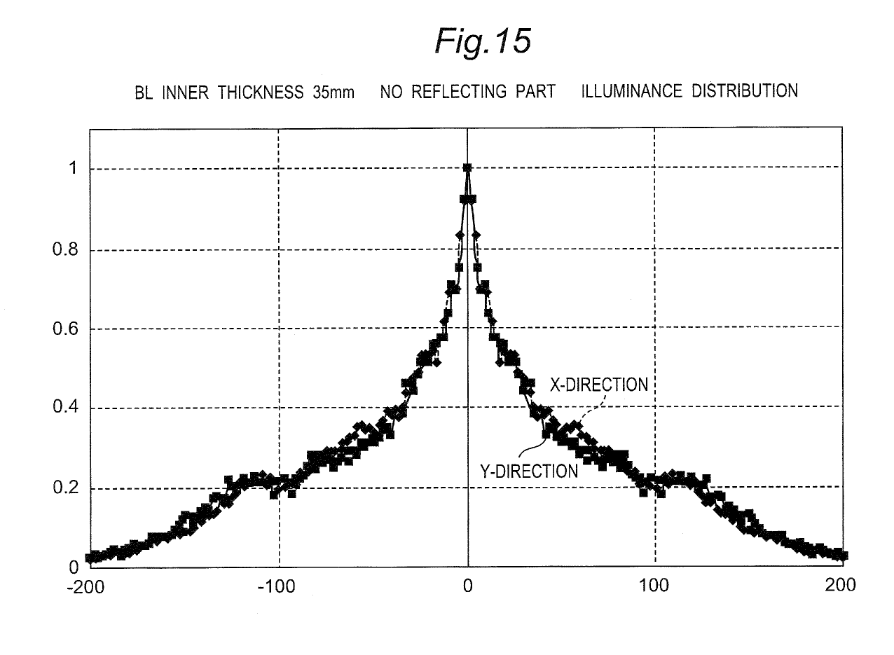

FIG. 15 illustrates an illuminance distribution on the irradiated surface 4a when the reflection unit 34 of the lens 3 used in the light emitting device 1 of Example 1 is eliminated.

As can be seen from FIGS. 10 and 15, the illuminance can be suppressed near the optical axis on the irradiated surface 4a by providing the reflection unit 34, and the light from the light source 2 can efficiently be expanded.

For example, an angle θ (see FIGS. 5A and 5B) formed between the reflection unit 34 and the bottom surface 33 ranges from greater than 15° to less than 45°. When the angle is less than or equal to 15°, the effect to suppress the illuminance of the irradiated surface 4a decreases near the optical axis. When the angle is greater than or equal to 45°, the light emitted from the light source 2 directly irradiates the reflection unit 34, which results in the illuminance unevenness on the irradiated surface 4a.

For example, the reflection unit 34 is located on the outside in which a distance from the optical axis A to the reflection unit 34 is greater than or equal to 65% of the effective diameter of the lens 3. Since the light reflected at the side of the output surface 32 concentrates at the outside of the bottom surface 33, it is necessary to efficiently reflect such light of the outside toward the side of the output surface 32, and the insufficient effect is obtained when the reflection unit 34 is provided near the optical axis A.

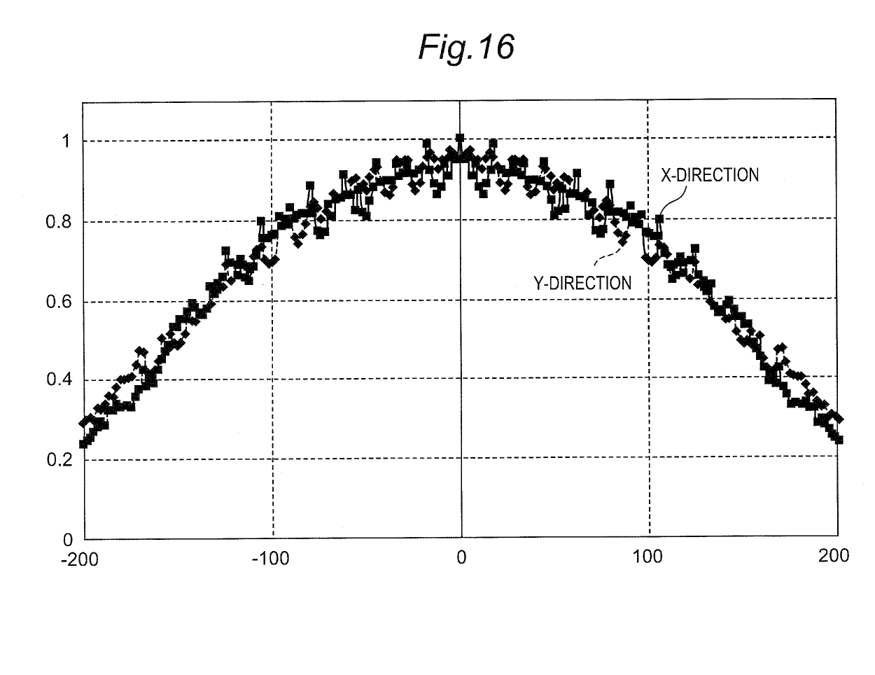

FIG. 16 illustrates a calculated illuminance distribution on the irradiated surface 4a of the diffuser plate 4 when five light emitting devices 1 of Example 1, in each of which the lens 3 in which the incident surface 31 is the anamorphic curved surface is used, are disposed in one line at a pitch of 60 mm and when the diffuser plate 4 is disposed 35 mm away from the emission surface 21 of the light source 2 in the optical axis direction. The reason a fine wave is observed in the illuminance distribution of FIG. 16 is that the number of evaluated rays is insufficient in performing an illuminance calculation.

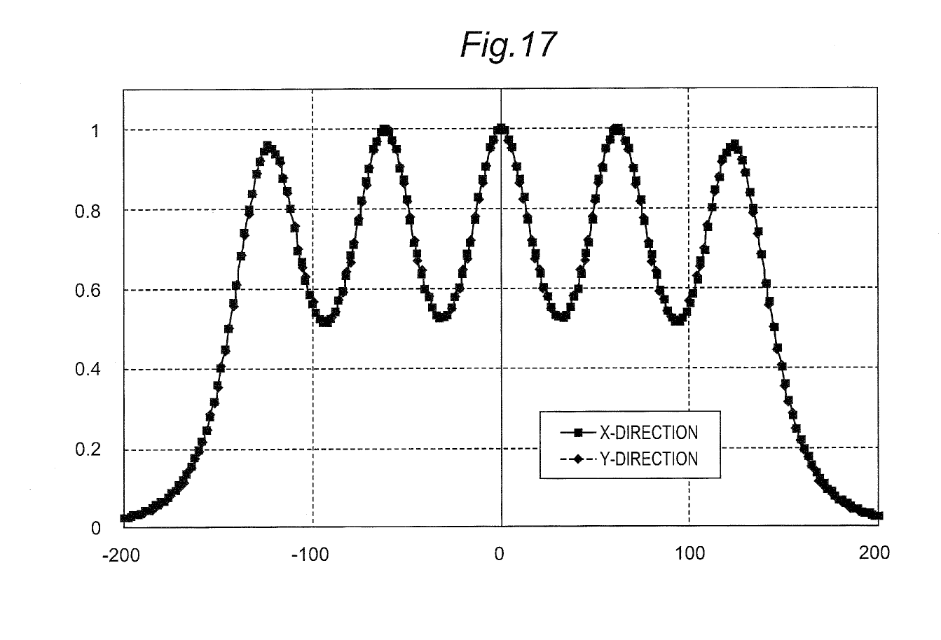

FIG. 17 illustrates a calculated illuminance distribution on the irradiated surface 4a of the diffuser plate 4 when five LED light sources 2 with no use of the lens 3 are disposed in one line at the pitch of 60 mm and when the diffuser plate 4 is disposed 35 mm away from the surface of the LED light source 2 in the optical axis direction.

When the illuminance distribution in FIG. 16 is compared to that in FIG. 17, it is found that the irradiated surface 4a of the diffuser plate 4 can evenly be illuminated by the effect of the lens 3 in FIG. 16.

The first to third embodiments are described as an example of the technology disclosed in the present application. However, the technology of the disclosure is not limited to the first to third embodiments. For example, the technology of the disclosure can also be applied to an embodiment in which a change, a replacement, an addition, and an omission are properly performed.

It is to be noted that, by properly combining the arbitrary embodiments of the aforementioned various embodiments, the effects possessed by them can be produced.

The disclosure also has the following configuration.

In accordance with a second aspect of the disclosure, a surface light source includes a plurality of light emitting devices and a diffuser plate. The plurality of light emitting devices is disposed in a planar manner. The diffuser plate is disposed so as to cover the plurality of light emitting devices and radiates light, which is irradiated on an irradiated surface of the diffuser plate from the plurality of light emitting devices, from a radiation surface of the diffuser plate while diffusing the light. Each of the plurality of light emitting devices is the light emitting device of the first aspect.

In accordance with a third aspect of the disclosure, a liquid crystal display device includes a liquid crystal display panel and the surface light source according to the second aspect that is disposed on the back side of the liquid crystal display panel.

In accordance with a fourth aspect of the disclosure, a lens expanding light from a light emitting diode includes an incident surface and an output surface. The incident surface is a surface to which light from the light emitting diode is entered at an optical axis and around the optical axis. The output surface is a surface from which the incident light is output while radially expanded. The incident surface includes a continuous concave surface, and the output surface includes a continuous convex surface. Further the lens is configured to have a refractive power in a first direction orthogonal to the optical axis different from a refractive power in a second direction orthogonal to the optical axis and the first direction in at least one of the incident surface and the output surface of the lens.

In the surface light source of the second aspect and the liquid crystal display device of the third aspect including the light emitting device, the color unevenness can be reduced on the irradiated surface to equalize the luminance and the color. In the lens of the fourth aspect, the refractive power in the first direction differs from the refractive power in the second direction in at least one of the incident surface and the output surface, so that the color unevenness can be reduced on the irradiated surface to equalize the luminance and the color.

Although the present disclosure has been fully described in connection with the embodiments thereof with reference to the accompanying drawings, it is to be noted that various changes and modifications are apparent to those skilled in the art. Such changes and/or modifications are to be understood as included within the scope of the present disclosure as defined by the appended claims unless they depart therefrom.

The components described in the accompanying drawings and the detailed description include not only components necessary for solving the problem but also components unnecessary for solving the problem for the purpose of the illustration of the technology. Therefore, it is to be noted that the fact that the component(s) unnecessary for solving the problem is described in the accompanying drawing(s) and the detailed description should not be immediately recognized that the component(s) unnecessary for solving the problem is the necessary component(s).

As described above, according to the disclosure, the present disclosure is useful to provide the surface light source having the small color unevenness and the sufficient brightness.

What is claimed is:

1. A light emitting device comprising:
a light source; and
a lens configured to be disposed to cover the light source and configured to expand light from the light source,
the lens further including: an incident surface through which the light from the light source is entered at an optical axis and around the optical axis; and an output surface from which the light entered into the lens is output,
the incident surface including a continuous concave surface, the output surface including a continuous convex surface, and the lens configured to have different refractive powers in a first direction orthogonal to the optical axis and in a second direction orthogonal to the optical axis and the first direction.

2. The light emitting device according to claim 1, wherein the incident surface includes an anamorphic aspheric curved surface in which the refractive power in the first direction differs from the refractive power in the second direction.

3. The light emitting device according to claim 1, wherein
the lens further includes a bottom surface configured to be located around the incident surface and located on an opposite side to the output surface, and
the bottom surface includes a reflection unit having a concave shape along the optical axis.

4. The light emitting device according to claim 3, wherein
the incident surface is a concave surface including an anamorphic and aspheric curved surface in which the refractive power in the first direction differs from the refractive power in the second direction, and
the output surface is a convex surface which is rotationally symmetrical with respect to the optical axis.

5. The light emitting device according to claim 3, wherein the reflection unit is disposed into a circular shape or an elliptical shape around the optical axis.

6. The light emitting device according to claim 3, wherein the reflection unit has an angle θ formed between the reflection unit and the bottom surface, and the angle θ satisfies a conditional expression of 15°<θ<45°.

7. The light emitting device according to claim 3, wherein at least one reflection unit is disposed at an outside in which a distance from the optical axis to the reflection unit is greater than or equal to 65% of an effective diameter of the lens.

8. The light emitting device according to claim 1, wherein the light source includes a light emitting element and a fluorescent layer formed into a dome shape on the light emitting element, and an emission surface is formed on a surface of the fluorescent layer.

9. A surface light source comprising:
a plurality of light emitting devices each of which includes a light source and a lens configured to be disposed to cover the light source and configured to expand light from the light source;
a diffuser plate configured to be disposed opposite to the light emitting devices and be extended orthogonal to an optical axis of the light source; and
a reflecting member configured to reflect light output from the light emitting devices toward the diffuser plate side,
the lens having different refractive powers in a first direction orthogonal to the optical axis and in a second direction orthogonal to the optical axis and the first direction, and
the plurality of light emitting devices being disposed opposite to the diffuser plate while dispersed.

10. A liquid crystal display device comprising:
a liquid crystal display panel; and
a surface light source configured to be disposed at a back surface side of the liquid crystal display panel and have a size equivalent to the liquid crystal display panel,
the surface light source including: a light emitting device having a light source and a lens, the lens being disposed while covering the light source and expanding light from the light source; a diffuser plate configured to be disposed opposite to the light emitting device while being adjacent to the liquid crystal display panel and be extended orthogonal to an optical axis of the light source; and a reflecting member configured to reflect the light output from the light emitting device toward the diffuser plate side,
the surface light source disposes a plurality of the light emitting devices opposite to the diffuser plate while dispersed,
the lens of the light emitting device including: an incident surface through which the light from the light source is entered at an optical axis and around the optical axis; and an output surface from which the light entered into the lens is output,
the incident surface including a continuous concave surface, the output surface including a continuous convex surface, and the lens configured to have different refractive powers in a first direction orthogonal to the optical axis and in a second direction orthogonal to the optical axis and the first direction in at least one of the incident surface and the output surface of the lens.

11. A lens which expands light from a light emitting diode comprising:
an incident surface through which the light from the light emitting diode is entered at an optical axis and around the optical axis; and
an output surface from which the light entered into the lens is output while radially expanded,
the incident surface including a continuous concave surface, the output surface including a continuous convex surface, and the lens configured to have different refractive powers in a first direction orthogonal to the optical axis and in a second direction orthogonal to the optical axis and the first direction in at least one of the incident surface and the output surface of the lens.

12. The lens according to claim 11, wherein the incident surface includes an anamorphic and aspheric curved surface in which the refractive power in the first direction differs from the refractive power in the second direction.

13. The lens according to claim 11, further comprising a bottom surface configured to be located around the incident surface and located on an opposite side to the output surface, wherein
the bottom surface includes a reflection unit having a concave shape along the optical axis.

14. The lens according to claim 13, wherein
the incident surface is a concave surface including an anamorphic and aspheric curved surface in which the refractive power in the first direction differs from the refractive power in the second direction, and
the output surface is a convex surface which is rotationally symmetrical with respect to the optical axis.

15. The lens according to claim 13, wherein the reflection unit is disposed into a circular shape or an elliptical shape around the optical axis.

16. The lens according to claim 13, wherein the reflection unit has an angle θ formed between the reflection unit and the bottom surface, and the angle θ satisfies a conditional expression of 15°<θ<45°.

17. The lens according to claim 13, wherein at least one reflection unit is disposed on an outside in which a distance from the optical axis to the reflection unit is greater than or equal to 65% of an effective diameter of the lens.

18. The lens according to claim 11, wherein the light emitting diode includes a light emitting element and a fluorescent layer formed into a dome shape on the light emitting element, and an emission surface is formed on a surface of the fluorescent layer.
